(19) United States
(12) Patent Application Publication
(10) Pub. No.: US 2025/0309350 A1
(43) Pub. Date: Oct. 2, 2025

(54) ELECTROCHEMICAL APPARATUS AND ELECTRONIC DEVICE

(71) Applicant: Ningde Amperex Technology Limited, Ningde (CN)

(72) Inventors: Jianyu LIU, Ningde (CN); Rui WANG, Ningde (CN); Chao TANG, Ningde (CN); Xiang WANG, Ningde (CN)

(73) Assignee: Ningde Amperex Technology Limited, Ningde (CN)

(21) Appl. No.: 19/093,309

(22) Filed: Mar. 28, 2025

(30) Foreign Application Priority Data
Mar. 28, 2024 (CN) 202410370183.X

(51) Int. Cl. H01M 10/0567; H01M 4/02; H01M 4/133; H01M 4/134; H01M 4/36; H01M 4/38; H01M 4/583; H01M 10/0525

(52) U.S. Cl. CPC H01M 10/0567; H01M 4/133; H01M 4/134; H01M 4/364; H01M 4/386; H01M 4/583; H01M 10/0525; H01M 2004/027

(57) ABSTRACT

An electrochemical apparatus includes a negative electrode plate and an electrolyte. The negative electrode plate includes a negative electrode current collector and a negative electrode film layer disposed on at least one surface of the negative electrode current collector. In a direction facing away from the negative electrode current collector, the negative electrode film layer sequentially includes a first active substance layer and a second active substance layer, where a mass percentage of a silicon material in the first active substance layer is less than a mass percentage of the silicon material in the second active substance layer. The electrolyte includes a substance A with a structure shown in formula I.

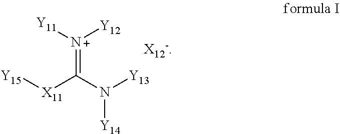

### CROSS-REFERENCE TO THE RELATED APPLICATION

This application claims the benefit of priority from the Chinese Patent Application No. 202410370183.X, filed on Mar. 28, 2024, the entire content of which is incorporated herein by reference.

### TECHNICAL FIELD

This application relates to the field of battery technology, and particularly to an electrochemical apparatus and an electronic device.

### BACKGROUND

In recent years, lithium-ion batteries, as a convenient electrochemical apparatus, have been widely used in electronic products such as notebook computer and mobile phone. With the market's pursuit of service life of electronic products, the requirement for cycle capacity retention rate of lithium-ion batteries is getting higher and higher. A theoretical specific capacity of silicon reaches up to 4200 mAh/g, much greater than that of graphite. Silicon material is the most promising material to replace graphite as a negative electrode material for the next generation of lithium-ion batteries. However, during continuous charging and discharging, the silicon material is very prone to volume swelling and contraction, creating gaps between silicon materials, ultimately leading to the rupture of an SEI film, and affecting the transfer of electrons and lithium ions. The repair of the ruptured SEI film consumes electrolyte and active lithium, causing cycle decay.

The prior art usually uses composite silicon-graphite materials, but during the relaxation process after charging and discharging to a cutoff voltage, lithium ion migration occurs in composite silicon-graphite materials. This migration causes electron transfer and electrolyte decomposition reactions, and during deep discharge cycling (a discharge voltage during cycling slightly below a designed lower cutoff voltage), the decomposition reaction intensifies, causing continuous degradation and reconstruction of the protective film. This severely affects the service life of the battery.

### SUMMARY

In view of this, this application provides an electrochemical apparatus and an electronic device. A multi-layer coating method is applied to a negative electrode film layer in the electrochemical apparatus. The proportion of a silicon material added in each layer of coating slurry is adjusted so that a percentage of silicon in different active substance layers varies. Additionally, a substance A with a structure shown in formula I is further synergistically added to an electrolyte in this application. This can improve the deep discharge cycling performance of the electrochemical apparatus and the electronic device and take the high-temperature performance into account.

According to a first aspect, this application provides an electrochemical apparatus. The electrochemical apparatus includes a negative electrode plate and an electrolyte. The negative electrode plate includes a negative electrode current collector and a negative electrode film layer disposed on at least one surface of the negative electrode current collector, and the negative electrode film layer contains a silicon material. In a direction facing away from the negative electrode current collector, the negative electrode film layer sequentially includes a first active substance layer and a second active substance layer. The first active substance layer is disposed between the negative electrode current collector and the second active substance layer, where a percentage of the silicon material in the first active substance layer is less than a percentage of the silicon material in the second active substance layer. The electrolyte contains a substance A with a structure shown in formula I;

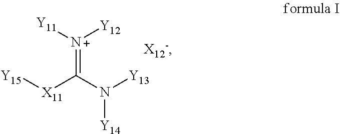

where
in the formula I, X₁₁ is selected from at least one of oxygen, sulfur, oxygen-containing alkylene group of C₁ to C₅, or sulfur-containing alkylene group of C₁ to C₅, X₁₂⁻ is a fluorine-containing anion, and X₁₂⁻ is selected from at least one of BF₄⁻, PF₆⁻, SO₃CF₃⁻, N(SO₂CF₃)₂⁻, CO₂CF₃⁻, N(SO₂C₂F₅)₂⁻, N(SO₂C₄F₉)₂⁻, C₃N₂(CN)₂(CF₃)⁻, or C₃N₂(CN)₂(C₂F₅)⁻;
Y₁₁ to Y₁₄ are each independently selected from acyloxy group, cyano group, isocyano group, substituted or unsubstituted alkyl group of C₁ to C₅, substituted or unsubstituted alkenyl group of C₂ to C₅, substituted or unsubstituted aryl group, or substituted or unsubstituted alkoxy group of C₁ to C₅; and in a case of substitution, the substituent group is each independently selected from fluorine, or alkyl group of C₁ to C₄;
Y₁₅ is selected from the group shown in formula II;

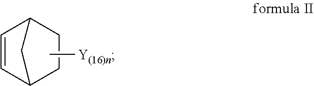

where
in the formula II, Y₍₁₆₎ₙ is selected from keto group, aldehyde group, substituted or unsubstituted alkyl group of C₁ to C₅, substituted or unsubstituted alkenyl group of C₂ to C₅, substituted or unsubstituted aryl group, amino group, nitro group, acyloxy group, substituted or unsubstituted alkoxy group of C₁ to C₅, siloxane group, carboxyester group, carbonate group, sulfonate group, sulfinate group, phosphate group, phosphinate group, cyano group, isocyano group, succinimide group, maleimide group, sulfonimide group, or heterocyclic group; and in a case of substitution, the substituent group is each independently selected from fluorine, or alkyl group of C₁ to C₄;
X₁₁ and Y₁₅ are connected through a carbon atom in the formula II; or,
X₁₁ and Y₁₅ are connected through a carbon atom, silicon atom, nitrogen atom, oxygen atom, or sulfur atom on Y₍₁₆₎ₙ in the formula II.

The silicon material undergoes irreversible swelling during cycling, and continues to come into contact with the electrolyte during swelling and contraction, causing consumption of the electrolyte. Lithium migration tends to shift from graphite to silicon in terms of materials and from an active substance far away from the current collector to an active substance close to the current collector in terms of space. Therefore, the inventors adjust a percentage of a silicon material in the negative electrode film layer to increase layer by layer in the direction facing away from the negative electrode current collector. In addition, adding a substance A with the structure shown in the formula I in the electrolyte can improve the deep discharge cycling performance of the lithium-ion battery and take the high-temperature performance into account.

The inventors speculate that because the substance A is positively charged, under the action of an electric field, cations gather at the negative electrode. During the formation stage, the substance A undergoes ring-opening to produce diene functional groups with polymerization effects, as shown in formula III. The compound in the formula III undergoes a polymerization reaction to form a uniform SEI organic layer, and this is conducive to enhancing the flexibility of the SEI. In addition, in combination with the negative electrode film layer with the percentage of silicon increasing layer by layer as described in this application, this is conducive to reducing the consumption of the electrolyte and inhibiting the swelling of the silicon material, thereby alleviating the self-discharge of the lithium-ion battery.

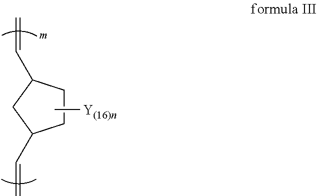

In some embodiments, the substance A is selected from at least one of the following compounds;

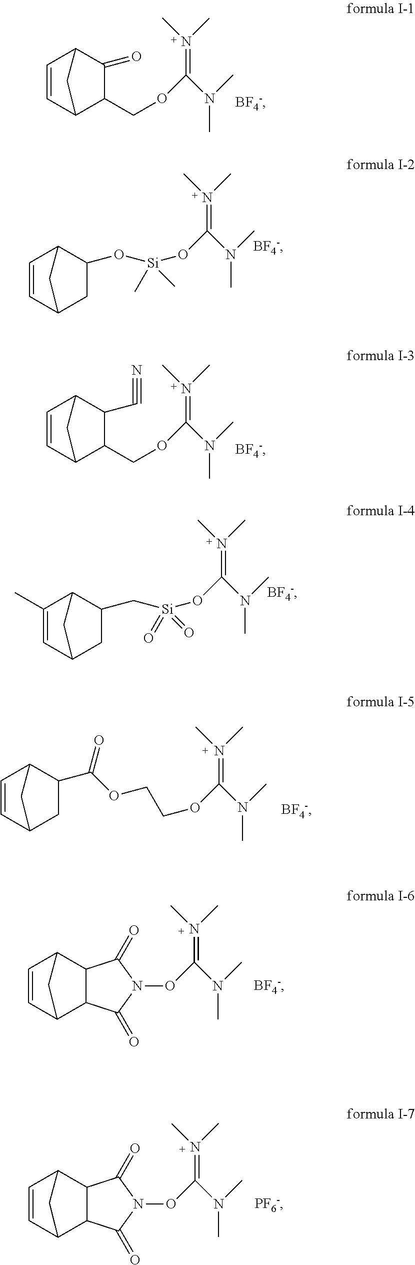

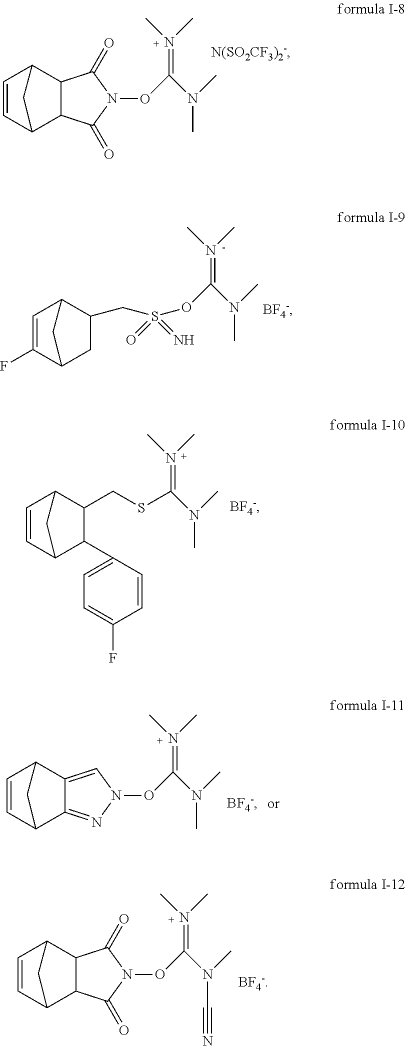

When including the substances of the formula I-1 to the formula I-12, the electrolyte can synergize with the negative electrode film layer with the foregoing different percentages of silicon, thereby improving the deep discharge cycling performance of the electrochemical apparatus and take the high-temperature performance into account, especially the high-temperature storage performance.

In some embodiments, a percentage of the silicon material in the first active substance layer is X₁, and a percentage of the silicon material in the second active substance layer is X₂, where 0%≤X₁≤70%, and 20%≤X₂≤90%. The two active substance layers of this application are sequentially arranged in a thickness direction of the negative electrode current collector; the thickness direction of the negative electrode current collector is consistent with the thickness direction of the negative electrode plate; and the first active substance layer is disposed between the negative electrode current collector and the second active substance layer, with the percentage of silicon in the first active substance layer and the second active substance layer increased gradually.

In combination with the electrolyte in this application, this is more conducive to inhibiting the swelling of active substances (silicon materials and carbon materials) and reducing the consumption of the electrolyte. It should be noted that the difference in percentage of silicon between layers is achieved by adjusting a mass proportion of a silicon material in each layer. Specific operations can refer to conventional methods in the prior art and will not be described.

In some embodiments, the percentage X₁ of silicon in the first active substance layer is 0% to 25%, and the percentage X₂ of silicon in the second active substance layer is 20% to 40%.

In some embodiments, a total coating amount of the active substance layer on the negative electrode current collector is 1 mg/cm² to 10 mg/cm². Preferably, the total coating amount of the active substance layer is 1 mg/cm² to 6 mg/cm².

In some embodiments, after drying, a thickness of the first active substance layer is d1, where 5 μm≤d1≤20 μm, and a thickness of the second active substance layer is d2, where 5 μm≤d2≤30 μm.

In some embodiments, based on a mass of the electrolyte, a mass percentage of the substance A is a %, satisfying: 0.01≤a≤5. Thus, a better effect of improving SEI film flexibility is achieved, and this is more conducive to enhancing the deep discharge cycling performance of the lithium-ion battery while taking the high-temperature storage performance of the lithium-ion battery into account. Preferably, 0.1≤a≤5. More preferably, 0.5≤a≤3.

In some embodiments, 0.011≤a/X₂≤15. The degree of the SEI film rupture caused by the swelling of the negative electrode material is related to an amount of a silicon-containing material. Regulating 0.011≤a/X₂ is conducive to further enhancing the flexibility of the SEI film, improving deep discharge cycling performance. Synergistically regulating a/X₂≤15 is used to avoid decline in cycling performance and increase in direct current resistance due to an excessive amount of the substance A with the structure shown in the formula I. Preferably, 1.5≤a/X₂≤13.5.

In some embodiments, the electrolyte further includes fluoroethylene carbonate and carboxylic ester compounds. Based on the mass of the electrolyte, a mass percentage of fluoroethylene carbonate is b %, and a mass percentage of the carboxylic ester compounds is c%, where 0.05≤a/b≤1, 0.1≤(b/c)/X₂≤2.7, and 1≤b≤20.Fluoroethylene carbonate (FEC) can quickly form a film on the silicon material. The formed LiF is a film component allowing the cycling performance of silicon negative electrodes and mixed negative electrodes to be effectively improved. However, the alkyl lithium is resulted from FEC decomposition, and alkyl lithium is not resistant to HF and is easily decomposed, especially during deep discharge cycling (discharge voltage less than 3.0 V). The decomposition reaction intensifies, causing continuous degradation and reconstruction of the protective film. The substance A with the structure shown in the formula I can be used for reinforcing the LiF inorganic component in the protective film. In addition, due to the polymerization reaction of the compound in formula III, organic components such as alkyl lithium enhance their flexibility. This can improve the inhibitory effect on silicon swelling.

In this application, the content relationship between the substance A with the structure shown in the formula I, FEC, and carboxylic ester compounds in the electrolyte is regulated, and the content of the silicon material in the negative electrode film layer is regulated to increase layer by layer in the direction facing away from the negative electrode current collector. Thus, voltage windows used by lithium-ion batteries are broadened. This is conducive to further enhancing the cycling performance, especially during deep discharge cycling, and take the thermal performance of the lithium-ion batteries into account. Preferably, 3≤b≤15.

In some embodiments, the electrolyte further includes a substance B, where the substance B includes at least one of vinylene carbonate, vinylethylene carbonate, 1,3-propene sultone, 1,3-propane sultone, 3-hexenedinitrile, maleic anhydride, or triallyl methoxysilane. Based on the mass of the electrolyte, a mass percentage of the substance B is 0.1% to 4%. An appropriate amount of the substance B can undergo a cross-linking reaction with the substance A with the structure shown in the formula I during charging and discharging, facilitating the uniform film formation between the substance B and the substance A with the structure shown in the formula I. This better improves the deep discharge cycling performance of lithium-ion batteries.

In some embodiments, the electrolyte further includes other organic solvents, where the other organic solvents include at least one of carbonate solvents, lactone solvents, or ether solvents. Preferably, the other organic solvents include at least one of ethylene carbonate (EC), propylene carbonate (PC), butylene carbonate, ethyl methyl carbonate, dimethyl carbonate, diethyl carbonate (DEC), dipropyl carbonate, methyl propyl carbonate, ethyl propyl carbonate, γ-butyrolactone, or γ-valerolactone.

In some embodiments, the electrolyte further includes lithium salts, where the lithium salts include at least one of lithium hexafluorophosphate (LiPF₆), lithium bis(trifluoromethanesulfonyl)imide (LiN(CF₃SO₂)₂, LiTFSI for short), lithium bis(fluorosulfonyl)imide (Li(N(SO₂F)₂), LiFSI for short), lithium bis(oxalato)borate (LiB(C₂O₄)₂, LiBOB for short), or lithium difluorooxalate borate (LiBF₂(C₂O₄), LiDFOB for short), preferably, LiPF₆ or LiTFSI.

In some embodiments, the negative electrode film layer further includes a carbon material, where the carbon material is selected from at least one of artificial graphite, natural graphite, soft carbon, or hard carbon. The silicon material includes a silicon composite material and/or elemental silicon, and the silicon composite material includes a silicon carbon material and/or a silicon oxide material SiOₓ, where 0.5≤x≤1.5. The silicon carbon material contains silicon element, carbon element, and oxygen element, where a mass ratio of silicon element, carbon element, and oxygen element is from 1:1:1 to 6:3:0.

In some embodiments, in each active substance layer, a mass ratio of the silicon material to the carbon material is 1:(0.2 to 15). The silicon material and the carbon material are collectively referred to as active substances. A mass ratio of the active substances, a binder, and a conductive agent is (70 to 99):(0.5 to 15):(0.5 to 15). Based on a total mass of the negative electrode film layer, a mass percentage of the silicon material is 2% to 80%. Preferably, the mass percentage of the silicon material is 10% to 30%.

In some embodiments, the electrochemical apparatus has a discharge voltage of less than 3.0 V during cycling. In composite graphite-silicon electrodes, silicon with high energy density mainly contributes capacity at the end of the discharge voltage of the battery. Therefore, by lowering the cycling lower limit voltage (deep discharge cycling), a lithium-ion battery with high energy density can be designed.

According to a second aspect, this application provides an electronic device. The electronic device includes the foregoing electrochemical apparatus.

The electrochemical apparatus provided in the first aspect of this application has good deep discharge cycling performance and high-temperature storage performance, with energy density also being taken into account. Therefore, the electronic device provided in the second aspect of this application also has high energy density, excellent deep discharge cycling performance, and high-temperature storage performance.

### BRIEF DESCRIPTION OF DRAWINGS

To describe the technical solutions in the embodiments of this application or in the prior art more clearly, the following briefly describes the accompanying drawings required for describing the embodiments or the prior art. Apparently, the accompanying drawings in the following description show only some embodiments of this application, and persons of skill in the art may still derive other drawings from these accompanying drawings without creative efforts.

FIGURE is a schematic structural diagram of double-layer coating on one side of a negative electrode plate in an electrochemical apparatus of this application;

In the FIGURE: 10, negative electrode plate; 101, negative electrode current collector; 102, first active substance layer; 103, second active substance layer; 1001, silicon material; 1002, carbon material.

### DETAILED DESCRIPTION

To make the objectives, technical solutions, and advantages of this application clearer and more comprehensible, the following describes this application in detail with reference to the embodiments and accompanying drawings. It should be understood that the specific embodiments described herein are merely used to explain this application but are not intended to limit this application.

### Negative Electrode Plate

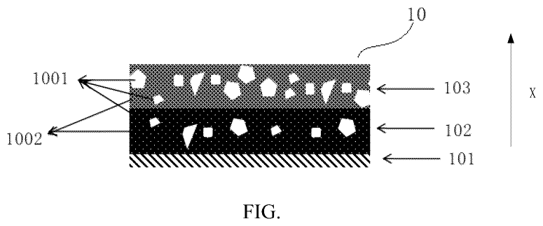

Referring to FIG. 1, it is a schematic structural diagram of an example of this application. A negative electrode plate 10 includes a negative electrode current collector 101 and a negative electrode film layer disposed on at least one surface of the negative electrode current collector. The negative electrode film layer contains a silicon material 1001 and a carbon material 1002. The negative electrode film layer includes a first active substance layer 102 and a second active substance layer 103. The first active substance layer 102 is disposed between the negative electrode current collector 101 and the second active substance layer 103, where a percentage of the silicon material in the first active substance layer 102 is less than a percentage of the silicon material in the second active substance layer 103.

For the negative electrode plate, a percentage of the silicon material in the first active substance layer 102 is X₁, and a percentage of the silicon material in the second active substance layer 103 is X₂, where 0%≤X₁≤70%, and 20%≤X₂≤90%. A thickness of the first active substance layer 102 is denoted as d1, where 5 μm≤d1≤20 μm, and a thickness of the second active substance layer 103 is denoted as d2, where 5 μm≤d2≤30 μm. For example, the percentage X₁ of the silicon material in the first active substance layer 102 is 0%, 5%, 10%, 15%, 20%, 25%, 35%, 40%, 55%, 60%, 65%, or 70%, or a range defined by any two of the above values. For example, the percentage X₂ of the silicon material in the second active substance layer 103 is 20%, 30%, 40%, 60%, 70%, 80%, or 90%, or a range defined by any two of the above values. For example, the thickness d1 of the first active substance layer 102 is 5 μm, 8 μm, 10 μm, 12 μm, 15 μm, 18 μm, or 20 μm, or a range defined by any two of the above values. For example, the thickness d2 of the second active substance layer 103 is 5 μm, 10 μm, 15 μm, 20 μm, 25 μm, 30 μm, or a range defined by any two of the above values. In some embodiments, the carbon material is selected from at least one of artificial graphite, natural graphite, soft carbon, or hard carbon. The silicon material includes a silicon composite material and/or elemental silicon, and the silicon composite material includes a silicon carbon material and/or a silicon oxide material SiOₓ, where 0.5≤x<1.5.

In some embodiments, the silicon carbon material contains silicon element, carbon element, and oxygen element, where a mass ratio of silicon element, carbon element, and oxygen element is from 1:1:1 to 6:3:0.

In some embodiments, the silicon material and the carbon material are collectively referred to as active substances. A mass ratio of the active substances, a binder, and a conductive agent is (70 to 99):(0.5 to 15):(0.5 to 15).

### Electrolyte

An electrolyte includes a substance A with a structure shown in formula I;

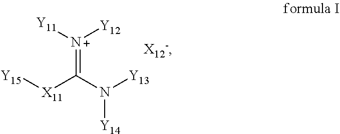

where
in the formula I, X₁₁ is selected from at least one of oxygen, sulfur, oxygen-containing alkylene group of C₁ to C₅, or sulfur-containing alkylene group of C₁ to C₅, X₁₂⁻ is a fluorine-containing anion, and X₁₂⁻ is selected from at least one of BF₄⁻, PF₆⁻, SO₃CF₃⁻, N(SO₂CF₃)₂⁻, CO₂CF₃⁻, N(SO₂C₂F₅)₂⁻, N(SO₂C₄F₉)₂⁻, C₃N₂(CN)₂(CF₃)⁻, or C₃N₂(CN)₂(C₂F₅)⁻;
Y₁₁ to Y₁₄ are each independently selected from acyloxy group, cyano group, isocyano group, substituted or unsubstituted alkyl group of C₁ to C₅, substituted or unsubstituted alkenyl group of C₂ to C₅, substituted or unsubstituted aryl group, or substituted or unsubstituted alkoxy group of C₁ to C₅; and in a case of substitution, the substituent group is each independently selected from fluorine, or alkyl group of C₁ to C₄;
Y₁₅ is selected from the group shown in formula II;

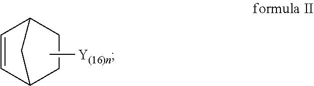

where
in the formula II, Y₍₁₆₎ₙ is selected from keto group, aldehyde group, substituted or unsubstituted alkyl group of C₁ to C₅, substituted or unsubstituted alkenyl group of C₂ to C₅, substituted or unsubstituted aryl group, amino group, nitro group, acyloxy group, substituted or unsubstituted alkoxy group of C₁ to C₅, siloxane group, carboxyester group, carbonate group, sulfonate group, sulfinate group, phosphate group, phosphinate group, cyano group, isocyano group, succinimide group, maleimide group, sulfonimide group, or heterocyclic group; and in a case of substitution, the substituent group is each independently selected from fluorine, or alkyl group of C₁ to C₄;
X₁₁ and Y₁₅ are connected through a carbon atom in the formula II; or,
X₁₁ and Y₁₅ are connected through a carbon atom, silicon atom, nitrogen atom, oxygen atom, or sulfur atom on Y₍₁₆₎ₙ in the formula II.

In some embodiments, the substance A is selected from at least one of the following compounds;

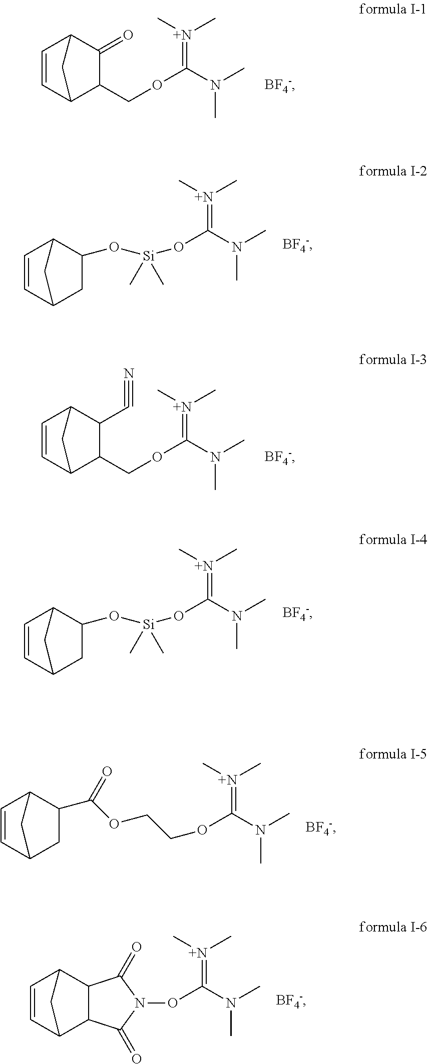

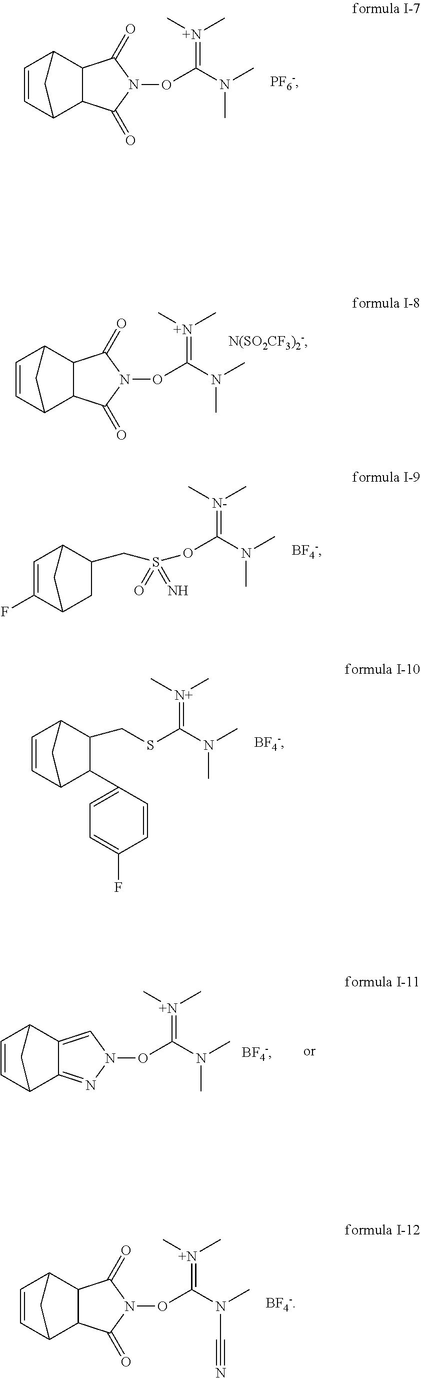

In some embodiments, based on a mass of the electrolyte, a mass percentage of the substance A is a%, satisfying: 0.01≤a≤5. For example, the mass percentage a% of the substance A is 0.01%, 0.1%, 0.3%, 0.5%, 0.8%, 1%, 1.5%, 2%, 3%, 4.5%, or 5%, or a range defined by any two of the above values.

In some embodiments, 0.011≤a/X₂≤15. For example, the value of a/X₂ is 0.011, 0.03, 0.05, 0.08, 0.1, 0.25, 0.3, 0.5, 1, 1.5, 2, 2.5, 3, 5, 8, 10, 13, 13.5, 14, or 15, or a range defined by any two of the above values.

In some embodiments, the electrolyte further includes fluoroethylene carbonate and carboxylic ester compounds. Based on the mass of the electrolyte, a mass percentage of fluoroethylene carbonate is b%, and a mass percentage of carboxylic ester compounds is c%, satisfying: 0.05≤a/b≤1, 0.1≤(b/c)/X₂≤2.7, and 1≤b≤20.

For example, the ratio of a/b is 0.05, 0.08, 0.1, 0.3, 0.5, 0.8, 0.9, or 1, or a range defined by any two of the above values. For example, the ratio of (b/c)/X₂ is 0.1, 0.5, 0.8, 0.7, 1, 1.3, 1.5, 1.8, 2, 2.1, 2.3, 2.5, or 2.7, or a range defined by any two of the above values. For example, the value of b is 1, 3, 5, 8, 10, 13, 15, 18, or 20, or a range defined by any two of the above values.

In some embodiments, the electrolyte further includes a substance B. The substance B includes at least one of cyclic carbonate compounds, cyclic sulfonate compounds, unsaturated nitrile compounds, unsaturated acid anhydride compounds, or unsaturated silane compounds. Preferably, the substance B is selected from at least one of vinylene carbonate, vinylethylene carbonate, 1,3-propene sultone, 1,3-propane sultone, 3-hexenedinitrile, maleic anhydride, or triallyl methoxysilane. Based on the mass of the electrolyte, a mass percentage of the substance B is 0.1% to 4%. For example, the mass percentage of the substance B is 0.1%, 1%, 1.5%, 2%, 2.5%, 3%, 3.5%, or 4%, or a range defined by any two of the above values.

### Electrochemical Apparatus

An electrochemical apparatus includes a positive electrode plate, a separator, the foregoing negative electrode plate, and the foregoing electrolyte.

The positive electrode plate includes a positive electrode current collector and a positive electrode active material layer disposed on a surface of the positive electrode current collector. The positive electrode current collector is not particularly limited in this application, provided that the objectives of this application can be achieved. For example, the positive electrode current collector may include aluminum foil, aluminum alloy foil, or a composite current collector (such as a composite current collector with a metal layer disposed on a polymer layer), or the like. The thickness of the positive electrode current collector is not particularly limited in this application, provided that the objectives of this application can be achieved. For example, a thickness of the positive electrode current collector is 5 μm to 12 μm. The positive electrode active material layer includes a positive electrode active material. The positive electrode active material is not particularly limited in this application, provided that the objectives of this application can be achieved. For example, the positive electrode active material may include but is not limited to lithium nickel cobalt manganese oxide (such as common NCM811, NCM622, NCM523, NCM111), lithium nickel cobalt aluminum oxide, lithium iron phosphate, lithium-rich manganese-based materials, lithium cobalt oxide, lithium manganese oxide, or lithium manganese iron phosphate. The thickness of the positive electrode active material layer is not particularly limited in this application, provided that the objectives of this application can be achieved. For example, a thickness of the positive electrode active material layer is 30 μm to 120 μm. The positive electrode active material layer may further include a conductive agent and a binder. Types of the conductive agent and the binder are not particularly limited in this application, provided that the objectives of this application can be achieved. For example, the conductive agent may include but is not limited to at least one of conductive carbon black, carbon nanotubes (CNT), carbon fibers, Ketjen black, graphene, metal materials, or conductive polymers. The binder may include but is not limited to at least one of polyacrylic acid, polyacrylate, acrylate polymer, polyvinyl alcohol, polyvinylidene fluoride, polytetrafluoroethylene, or vinylidene fluoride-hexafluoropropylene copolymer. The mass ratio of the positive electrode active material, conductive agent, and binder in the positive electrode active material layer is not particularly limited in this application, and persons skilled in the art can make selection based on actual needs, provided that the objectives of this application can be achieved.

The separator is not specifically limited in this application, and may be any well-known porous separator with electrochemical stability and chemical stability, for example, a mono-layer or multi-layer membrane made of one or more of glass fiber, non-woven fabric, polyethylene (PE), polypropylene (PP), and polyvinylidene fluoride (PVDF).

The electrochemical apparatus may be prepared by using the conventional methods in the art. For example, the positive electrode plate, the separator, and the negative electrode plate prepared are stacked in sequence, so that the separator is located between the positive electrode plate and the negative electrode plate for separation, to obtain an electrode assembly, or the resulting stack is wound to obtain an electrode assembly. The electrode assembly is placed in an outer package, and an electrolyte is injected, followed by sealing. The processes such as vacuum packaging, standing, formation, shaping, and capacity testing are performed to obtain an electrochemical apparatus.

The electrochemical apparatus in this application may include any apparatus in which electrochemical reactions occur. Specific examples of the apparatus include all types of primary batteries or secondary batteries. Especially, the electrochemical apparatus is a lithium secondary battery, including a lithium metal secondary battery, a lithium-ion secondary battery, a lithium polymer secondary battery, or a lithium-ion polymer secondary battery.

### Electronic Device

An electronic device of this application includes any of the electrochemical apparatuses of this application. In some embodiments, the electronic device of this application may be used without limitation in a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, and a lithium-ion capacitor.

The following describes the embodiments of this application more specifically by using examples and comparative examples. Unless otherwise stated, the parts, percentages, and ratios listed below are all based on weight, and the raw materials used are commercially available or can be synthesized by conventional methods.

### Example 1-1

### I. Preparation of Lithium-Ion Battery

### Preparation of Positive Electrode Plate

Positive electrode active material lithium cobalt oxide (LiCoO₂), conductive agent Super P, and binder polyvinylidene fluoride were mixed at a weight ratio of 97.9:0.4:1.7, added with N-methylpyrrolidone (NMP), and well stirred under the action of a vacuum mixer to obtain a positive electrode slurry. A positive electrode slurry was uniformly applied onto a positive electrode current collector aluminum foil, and the aluminum foil was dried. Then, after cold pressing, cutting, and slitting, drying was performed in vacuum to obtain a positive electrode plate.

### Preparation of Negative Electrode Plate

### First Active Substance Layer

Negative electrode active material artificial graphite, a silicon-carbon composite material (SiC, Si:C:O=1:1:0), thickener sodium carboxymethyl cellulose (CMC), and binder styrene-butadiene rubber (SBR) were mixed at a weight ratio of 75:22:1:2 and added with deionized water as a solvent to prepare a negative electrode slurry with a solid content of 54%, and the negative electrode slurry was stirred under the action of a vacuum mixer to obtain a uniform negative electrode slurry, a first negative electrode slurry.

### Second Active Substance Layer

Negative electrode active material artificial graphite, a silicon-carbon composite material (SiC, Si:C:O=1:1:0), thickener sodium carboxymethyl cellulose (CMC), and binder styrene-butadiene rubber (SBR) were mixed at a weight ratio of 59:38:1:2 and added with deionized water as a solvent to prepare a negative electrode slurry with a solid content of 54%, and the negative electrode slurry was stirred under the action of a vacuum mixer to obtain a uniform negative electrode slurry, a second negative electrode slurry.

The first negative electrode slurry and the second negative electrode slurry were uniformly applied in sequence (the first negative electrode slurry was applied first, and then the second negative electrode slurry was applied) onto a negative electrode current collector copper foil, and the copper foil was dried. Then, after cold pressing, cutting, and slitting, drying was performed in vacuum to obtain a negative electrode plate.

Example 1-15 to example 1-19 were differed from Example 1-1 in that in the preparation process of the negative electrode plate, the mass proportion of silicon materials in both the first active substance layer and the second active substance layer was adjusted. See Table 1 for details.

### Preparation of Electrolyte

In a dry argon atmosphere glove box, ethylene carbonate (EC), propylene

carbonate (PC), and propyl propionate (PP) were mixed at a mass ratio of 2:2:6. Then, substance A was added and dissolved, and the mixture was fully stirred. Then lithium salt LiPF₆ was added and mixed to uniformity to obtain an electrolyte. A percentage a of the substance A was a mass percentage calculated based on a total mass of the electrolyte.

Example 1-2 to Example 1-14 and Comparative Example 1-1 to Comparative Example 1-7 were differed from Comparative Example 1 in that in the preparation process of the electrolyte, the type and percentage of the substance A were adjusted separately. See Table 1 for details.

### Preparation of Separator

Boehmite and polyacrylate were mixed and dissolved in deionized water to form a coating slurry. Then, the coating slurry was uniformly applied onto two surfaces of a porous substrate by using a micro-gravure coating method, and dried to obtain a desired separator.

### Preparation of Lithium-Ion Battery

A positive electrode plate, a separator, and a negative electrode plate were stacked in sequence so that the separator was located between the positive electrode plate and the negative electrode plate to provide separation. Then, the resulting stack was wound to form a jelly roll. After tab welding, the jelly roll was placed in an outer package made of aluminum laminated film foil. The prepared electrolyte was injected into the jelly roll that was dried. The processes such as vacuum packaging, standing, formation, shaping, and capacity testing were performed to obtain a pouch lithium-ion battery.

### II. Performance Test

### (1) Deep Discharge Cycling Performance Test of Lithium-Ion Battery

The lithium-ion battery was placed in a 35° C. thermostat and left there for 30 minutes so that the lithium-ion battery reached a constant temperature. The lithium-ion battery that had reached a constant temperature was charged at a constant current of 2C to a voltage of 4.5 V, then charged at a constant voltage of 4.5 V to a current of 0.05C, and then discharged at a constant current of 0.7C to a voltage of 2.7 V. This was one charge and discharge cycle. The charging and discharging were performed repeatedly by starting from a 100% first-cycle discharge capacity. The capacity after 500 cycles divided by the first-cycle discharge capacity was recorded as a cycle capacity retention rate and as an indicator for evaluating the cycling performance of the lithium-ion battery.

### (2) High-Temperature Performance Test

At 25° C., the lithium-ion battery was left standing for 30 minutes, then charged at a constant current of 2C to 4.5 V, and charged to 0.05C at a constant voltage of 4.5 V. After left standing for 5 minutes, the lithium-ion battery was stored at 70° C. for 7 days, and a thickness of a battery cell of the battery was measured. A thickness swelling rate of the battery cell of the battery was calculated according to the following formula:

Thickness swelling rate=[(thickness after storage−thickness before storage)/thickness before storage]×100%.

### (3) Test for Percentage of Silicon Material in Active Substance Layer

In the thickness direction of the negative electrode plate, powder samples in an active substance layer were scraped from a region 5 μm thick from the surface of the negative electrode plate, and the percentage Y₂ of the silicon element in the second active substance layer was measured using an inductively coupled plasma optical spectrometer (ICP); and powder samples in the active substance layer were scraped from a region 5 μm thick from the negative electrode current collector, and the percentage Y₁ of the silicon element in the first active substance layer was measured using the ICP.

### Si:C:O Ratio Measurement

A dried negative electrode plate was fixed on a sample stage, and the sample stage with the holder was placed in a CP instrument (IB-09010CP/ion polisher) and adjusted to a suitable position for sectional polishing treatment. After cutting, the sample was taken out and placed in an SEM-EDS instrument (ZEISS SEM-OXFORD EDS) for scanning electron microscopy combined with elemental quantitative analysis.

The focus length, contrast, and brightness were adjusted at a magnification of 3KX, photos were taken, and point scanning was selected to collect EDS (energy spectrum) data. Ratios of Si, C, and O elements were obtained. A percentage of Si element in the first active substance layer to a total of Si+C+O elements was recorded as P₁, and a percentage of Si element in the second active substance layer to a total of Si+C+O elements was recorded as P₂.

Calculation for percentage of silicon material in the active substance layer:

$${X}_{1} = {Y}_{1} / {P}_{1} , and {X}_{2} = {Y}_{2} / {P}_{2.}$$

TABLE 1
Relationship between substance A and percentage of silicon in multi-layer negative electrode

| | | | | | | | Total | | | |
|---|---|---|---|---|---|---|---|---|---|---|
| | | | Negative electrode | | | | coating | | | |
| | | | active substance layer | | | | amount of | | | |
| | | | Percentage | | Percentage | | negative | | Capacity | Thickness |
| | Electrolyte | | X of silicon | Thickness | X₂ of silicon | Thickness | electrode | | retention | growth |
| | Substance A | | material of | of first | material of | of second | active | | rate after | rate after |
| | with structure | | first active | active | second active | active | substance | | 500 cycles | 7-day |
| | shown in | | substance | substance | substance | substance | layer | | at 35° C. | storage at |
| | formula I | a | layer | layer (μm) | layer | layer (μm) | (mg/cm²) W | a/X₂ | and 4.45 V | 70° C. |
| Comparative | / | / | 22% | 8 | 38% | 8 | 2.0 | / | 75% | 13% |
| Example 1-1 | | | | | | | | | | |
| Comparative | Norbornylene | 1.0 | 60% | 10. | / | / | 2.0 | / | 75% | 12% |
| Example 1-2 | | | | | | | | | | |
| Comparative | Tetramethylurea | 1.0 | 22% | 8 | 38% | 8 | 2.0 | 2.7 | 75% | 13% |
| Example 1-3 | | | | | | | | | | |
| Comparative | Substance C | 1.0 | 22% | 8 | 38% | 8 | 2.0 | 2.7 | 74% | 14% |
| Example 1-4 | | | | | | | | | | |
| Comparative | Substance D | 1.0 | 22% | 5 | 38% | 5 | 2.0 | 2.7 | 73% | 13% |
| Example 1-5 | | | | | | | | | | |
| Comparative | Substance E | 1.0 | 22% | 8 | 38% | 8 | 2.0 | 2.7 | 70% | 15% |
| Example 1-6 | | | | | | | | | | |
| Comparative | Formula I-7 | 0.5 | 0% | 5 | 0% | 5 | 2.0 | / | 70% | 12% |
| Example 1-7 | | | | | | | | | | |
| Example 1-1 | Formula I-1 | 1.0 | 22% | 8 | 38% | 8 | 2.0 | 2.7 | 88% | 11% |
| Example 1-2 | Formula I-2 | 1.0 | 22% | 8 | 38% | 8 | 2.0 | 2.7 | 89% | 12% |
| Example 1-3 | Formula I-3 | 1.0 | 22% | 8 | 38% | 8 | 2.0 | 2.7 | 88% | 10% |
| Example 1-4 | Formula I-4 | 1.0 | 22% | 8 | 38% | 8 | 2.0 | 2.7 | 87% | 12% |
| Example 1-5 | Formula I-5 | 1.0 | 22% | 8 | 38% | 8 | 2.0 | 2.7 | 88% | 9% |
| Example 1-6 | Formula I-7 | 1.0 | 22% | 8 | 38% | 8 | 2.0 | 2.7 | 90% | 8% |
| Example 1-7 | Formula I-10 | 1.0 | 22% | 8 | 38% | 8 | 2.0 | 2.7 | 86% | 12% |
| Example 1-8 | Formula 1-11 | 1.0 | 22% | 8 | 38% | 8 | 2.0 | 2.7 | 87% | 9% |
| Example 1-9′ | Formula I-7 | 0.005 | 22% | 8 | 38% | 8 | 2.0 | 0.013 | 80% | 13% |
| Example 1-9 | Formula I-7 | 0.01 | 22% | 8 | 38% | 8 | 2.0 | 0.03 | 85% | 13% |
| Example 1-10 | Formula I-7 | 0.1 | 22% | 8 | 38% | 8 | 2.0 | 0.3 | 86% | 11% |
| Example 1-11 | Formula I-7 | 0.5 | 22% | 8 | 38% | 8 | 2.0 | 1.3 | 88% | 10% |
| Example 1-12 | Formula I-7 | 3.0 | 22% | 8 | 38% | 8 | 2.0 | 8.0 | 88% | 7% |
| Example 1-13 | Formula I-7 | 5.0 | 22% | 8 | 38% | 8 | 2.0 | 13.3 | 87% | 7% |
| Example 1-14 | Formula 1-7 | 5.5 | 22% | 8 | 38% | 8 | 2.0 | 14.7 | 84% | 6% |
| Example 1-15 | Formula I-7 | 0.5 | 0% | 5 | 30% | 5 | 2.0 | 1.7 | 89% | 9% |
| Example 1-16 | Formula I-7 | 0.5 | 0% | 5 | 20% | 5 | 6.0 | 2.5 | 90% | 9% |
| Example 1-17 | Formula I-7 | 0.5 | 70% | 11 | 90% | 11 | 1.2 | 0.6 | 86% | 12% |
| Example 1-18 | Formula I-7 | 0.5 | 60% | 10. | 80% | 10. | 3.5 | 0.6 | 87% | 11% |
| Example 1-18 | Formula I-7 | 0.5 | 0% | 5 | 20% | 5 | 1.0 | 2.5 | 92% | 8% |
| Example 1-19 | Formula I-7 | 0.5 | 0% | 5 | 20% | 5 | 5.0 | 2.5 | 91% | 8.5% |

Note:
The substance C is 2-(7-azabenzotriazole)-N,N,N′,N′-tetramethylurea tetrafluoroborate (CAS: 873798-09-5), the substance D is 2-(2-pyridone-1-yl)-1,1,3,3-tetramethylurea tetrafluoroborate (CAS: 125700-71-2), and the substance E is O-(3,4-dihydro-4-oxo-1,2,3-benzotriazole-3-yl)-N,N,N′,N′-tetramethylurea hexafluorophosphate (CAS: 164861-52-3).

As shown in Table 1, from the comparisons between Comparative Example 1-1 to Comparative Example 1-7 and Example 1-1, it can be seen that the composite negative electrode with different percentages of silicon in multiple layers, especially the composite negative electrode with percentage of silicon gradually increasing in the direction facing away from the current collector, can synergize with the substance A with the structure shown in the formula I. This is conducive to alleviating the self-discharge of the lithium-ion battery and reducing consumption of the electrolyte, improving cycling performance of the lithium-ion battery and decreasing the thickness growth rate at high temperature to some extent. Example 1-2 to Example 1-8 further adjusted the selection of the substance A with the structure shown in the formula I, and similar conclusion can be obtained. From the comparisons between Example 1-9′, and Example 1-9 to Example 1-14 and Example 1-1, it can be seen that the percentage of the substance A with the structure shown in the formula I is appropriate. This is more conducive to working with the composite negative electrode with different percentages of silicon in multiple layers, to improve the deep discharge cycling and high-temperature storage performance of the lithium-ion battery. Specifically, when the electrolyte contains an appropriate amount of the substance A with the structure shown in the formula I, and the percentage of the silicon material in the first active substance layer and the percentage of the silicon material of the second active substance layer are also within the above range, the effect of improving the cycling performance and high-temperature storage performance of the lithium-ion battery is better.

Table 2 shows further adjustment based on Example 1-1, mainly reflected in the addition of an appropriate amount of FEC and a suitable carboxylic ester compound to the electrolyte containing the substance A with the structure shown in the formula I. See Table 2 for details.

TABLE 2

| | | | | | | | | | Capacity | |
|---|---|---|---|---|---|---|---|---|---|---|
| | | | | | | | | | retention | Thickness |
| | Substance A with | | | | | | | | rate after | growth rate |
| | structure shown | | Percentage | | Carboxylic ester | | | | 500 cycles | after 7-day |
| | in formula I | | of FEC | | compound | | | | at 35° C. | storage at |
| | Type | a/% | (b/%) | a/b | Type | c/% | X₂/% | (b/c)/X₂ | and 4.45 V | 70° C. |
| Example 1-1 | Formula I-1 | 1.0 | 10 | 0.1 | / | / | 0.38 | / | 88% | 11% |
| Comparative | Formula I-1 | 1.0 | / | / | / | / | 0.38 | / | 40% | 4% |
| Example 2-1 | | | | | | | | | | |
| Comparative | / | / | 10. | / | Ethyl propionate | 20.0 | 0.38 | 1.3 | 75% | 14% |
| Example 2-2 | | | | | | | | | | |
| Example 2-1 | Formula I-1 | 1.0 | 10 | 0.1 | Ethyl propionate | 20.0 | 0.38 | 1.3 | 90% | 9% |
| Example 2-2 | Formula I-1 | 1.0 | 1 | 1 | Ethyl propionate | 20.0 | 0.38 | 0.1 | 89.5% | 5% |
| Example 2-3 | Formula I-1 | 1.0 | 3 | 0.33 | Ethyl propionate | 20.0 | 0.38 | 0.4 | 92% | 7% |
| Example 2-4 | Formula I-1 | 1.0 | 5 | 0.2 | Ethyl propionate | 20.0 | 0.38 | 0.7 | 93% | 8% |
| Example 2-5 | Formula I-1 | 1.0 | 15 | 0.07 | Ethyl propionate | 20.0 | 0.38 | 2.0 | 91.5% | 10% |
| Example 2-6 | Formula I-1 | 1.0 | 17 | 0.06 | Ethyl propionate | 20.0 | 0.38 | 2.3 | 89% | 10% |
| Example 2-7 | Formula I-1 | 1.0 | 20 | 0.05 | Ethyl propionate | 20.0 | 0.38 | 2.7 | 90% | 11% |
| Example 2-8 | Formula I-1 | 1.0 | 22 | 0.045 | Ethyl propionate | 20.0 | 0.38 | 2.9 | 83% | 14% |
| Example 2-9 | Formula I-1 | 1.0 | 14 | 0.07 | Ethyl acetate | 10.0 | 1.05 | 1.3 | 89.5% | 11% |
| Example 2-10 | Formula I-1 | 1.0 | 14 | 0.07 | Propyl propionate | 10.0 | 1.05 | 1.3 | 89% | 12% |
| Example 2-11 | Formula I-1 | 1.0 | 14 | 0.07 | Ethyl | 10.0 | 1.05 | 1.3 | 89% | 12% |
| | | | | | difluoroacetate | | | | | |
| Example 2-12 | Formula I-1 + | 0.5 + 0.5 | 14 | 0.07 | Ethyl | 10.0 | 1.05 | 1.3 | 89% | 12% |
| | Formula I-12 | | | | difluoroacetate | | | | | |

Combined with Table 2, it can be seen that, in this application, an appropriate amount of FEC and a suitable carboxylic ester compound were further added to the electrolyte in Table 1 to further enhance the deep discharge cycling performance and thermal performance of the lithium-ion battery.

Table 3 shows further adjustment based on Example 1-1, mainly reflected in the addition of an appropriate amount of the substance B to the electrolyte containing the substance A with the structure shown in the formula I. See Table 3 for details.

TABLE 3

| | | | | | Capacity | |
|---|---|---|---|---|---|---|
| | | | | | retention | Thickness |
| | Substance A | | | | rate after | growth rate |
| | with structure | | Substance B | | 500 cycles | after 7-day |
| | shown in formula I | | | Percentage/ | at 35° C. and | storage |
| | Type | a/% | Type | (%) | 4.45 V | at 70° C. |
| Example 1-1 | Formula | 1.0 | / | / | 88% | 11% |
| | (I-1) | | | | | |
| Comparative | / | / | VC | 1.0 | 87% | 14% |
| Example 3-1 | | | | | | |
| Comparative | / | / | 1,3-propene | 1.0 | 87% | 12% |
| Example 3-2 | | | sultone | | | |
| Comparative | / | / | 3-hexenedinitrile | 1.0 | 87% | 11% |
| Example 3-3 | | | | | | |
| Comparative | / | / | 3-hexenedinitrile | 3.0 | 86% | 12% |
| Example 3-4 | | | | | | |
| Comparative | / | / | Maleic | 1.0 | 87% | 14% |
| Example 3-5 | | | anhydride | | | |
| Comparative | / | / | Triallyl | 1.0 | 88% | 13% |
| Example 3-6 | | | methoxysilane | | | |
| Comparative | / | / | Maleic | 1.0 + 1.0 | 86% | 12% |
| Example 3-7 | | | anhydride + | | | |
| | | | Triallyl | | | |
| | | | methoxysilane | | | |
| Example 3-1 | Formula | 1.0 | VC | 1.0 | 90% | 12% |
| | (I-1) | | | | | |
| Example 3-2 | Formula | 1.0 | 1,3-propene | 1.0 | 90% | 10% |
| | (I-1) | | sultone | | | |
| Example 3-3 | Formula | 0.5 | VC + 1,3-propane | 1.0 + 3.0 | 92% | 11% |
| | (I-1) | | sultone | | | |
| Example 3-4 | formula | 1.0 | 3-hexenedinitrile | 1.0 | 90% | 9% |
| | (I-1) | | | | | |
| Example 3-5 | Formula | 0.5 | 3-hexenedinitrile | 3.0 | 89% | 10% |
| | (I-1) | | | | | |
| Example 3-6 | formula | 1.0 | Maleic | 1.0 | 90% | 12% |
| | (I-1) | | anhydride | | | |
| Example 3-7 | formula | 1.0 | Triallyl | 1.0 | 91% | 11% |
| | (I-1) | | methoxysilane | | | |
| Example 3-8 | Formula | 0.5 | Maleic | 1.0 + 1.0 | 93% | 10% |
| | (I-1) | | anhydride + | | | |
| | | | Triallyl | | | |
| | | | methoxysilane | | | |

Combined with Table 3, it can be seen that, in this application, an appropriate amount of at least one carboxylic ester compounds was further added to the electrolyte in Table 1 to further enhance the deep discharge cycling performance of the lithium-ion battery.

TABLE 4

| | | | | | | Capacity |
|---|---|---|---|---|---|---|
| | First active | | Second active | | | retention |
| | substance layer | | substance layer | | Discharge | rate after |
| | Silicon | | Silicon | | lower | 500 cycles at |
| | material | Percentage/ | material | Percentage/ | limit | 35° C. and |
| | type | (%) | type | (%) | voltage | 4.45 V |
| Example 1-1 | Silicon | 0.22 | Silicon | 0.38 | 2.7 | 88% |
| | carbon | | carbon | | | |
| | material (a | | material (a | | | |
| | mass ratio of | | mass ratio | | | |
| | silicon | | of silicon | | | |
| | element, | | element, | | | |
| | carbon | | carbon | | | |
| | element, and | | element, | | | |
| | oxygen | | and oxygen | | | |
| | element was | | element was | | | |
| | 1:1:0) | | 1:1:0) | | | |
| Example 4-1 | Silicon | 0.22 | Silicon | 0.38 | 2.7 | 89% |
| | carbon | | oxide | | | |
| | material (a | | material | | | |
| | mass ratio of | | | | | |
| | silicon | | | | | |
| | element, | | | | | |
| | carbon | | | | | |
| | element, and | | | | | |
| | oxygen | | | | | |
| | element was | | | | | |
| | 1:1:0) | | | | | |
| Example 4-2 | Silicon oxide | 0.22 | Silicon | 0.38 | 2.7 | 88.5% |
| | material | | carbon | | | |
| | | | material (a | | | |
| | | | mass ratio | | | |
| | | | of silicon | | | |
| | | | element, | | | |
| | | | carbon | | | |
| | | | element, | | | |
| | | | and oxygen | | | |
| | | | element was | | | |
| | | | 6:3:0) | | | |
| Example 4-3 | Silicon | 0.22 | Silicon | 0.38 | 2.7 | 83% |
| | carbon | | oxide | | | |
| | material (a | | material | | | |
| | mass ratio of | | | | | |
| | silicon | | | | | |
| | element, | | | | | |
| | carbon | | | | | |
| | element, and | | | | | |
| | oxygen | | | | | |
| | element was | | | | | |
| | 4:2.5:1.5) | | | | | |

The foregoing descriptions are merely preferable embodiments of this application, but are not intended to limit this application. Any modification, equivalent replacement, or improvement made without departing from the spirit and principle of this application shall fall within the protection scope of this application.

What is claimed is:

1. An electrochemical apparatus, comprising a negative electrode plate and an electrolyte; wherein
the negative electrode plate comprises a negative electrode current collector and a negative electrode film layer disposed on at least one surface of the negative electrode current collector, and the negative electrode film layer contains a silicon material;
in a direction facing away from the negative electrode current collector, the negative electrode film layer sequentially comprises a first active substance layer and a second active substance layer, wherein X₁ is a mass percentage of the silicon material in the first active substance layer, X₂ is a mass percentage of the silicon material in the second active substance layer, X₁<X₂; and
the electrolyte comprises a substance A with a structure shown in formula I; 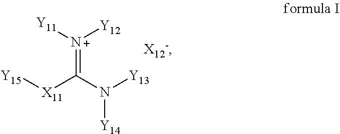
wherein
in the formula I, X₁₁ is at least one selected from oxygen, sulfur, oxygen-containing alkylene group of C₁ to C₅, or sulfur-containing alkylene group of C₁ to C₅; X₁₂⁻ is a fluorine-containing anion; and X₁₂⁻ is at least one selected from BF₄⁻, PF₆⁻, SO₃CF₃⁻, N(SO₂CF₃)₂⁻, CO₂CF₃⁻, N(SO₂C₂F₅)₂⁻, N(SO₂C₄F₉)₂⁻, C₃N₂(CN)₂(CF₃)^{-, or C}₃N₂(CN)₂(C₂F₅)^{-;}
Y₁₁ to Y₁₄ are each independently selected from acyloxy group, cyano group, isocyano group, substituted or unsubstituted alkyl group of C₁ to C₅, substituted or unsubstituted alkenyl group of C₂ to C₅, substituted or unsubstituted aryl group, or substituted or unsubstituted alkoxy group of C₁ to C₅; and in a case of substitution, the substituent group is each independently selected from fluorine, or alkyl group of C₁ to C₄;
Y₁₅ is selected from the group shown in formula II; 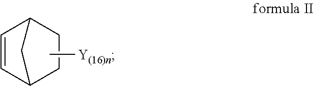
wherein
in the formula II, Y₍₁₆₎ₙ is selected from keto group, aldehyde group, substituted or unsubstituted alkyl group of C₁ to C₅, substituted or unsubstituted alkenyl group of C₂ to C₅, substituted or unsubstituted aryl group, amino group, nitro group, acyloxy group, substituted or unsubstituted alkoxy group of C₁ to C₅, siloxane group, carboxyester group, carbonate group, sulfonate group, sulfinate group, phosphate group, phosphinate group, cyano group, isocyano group, succinimide group, maleimide group, sulfonimide group, or heterocyclic group; and in a case of substitution, the substituent group is each independently selected from fluorine, or alkyl group of C₁ to C₄;
X₁₁ and Y₁₅ are connected through a carbon atom in the formula II, or, X₁₁ and Y₁₅ are connected through a carbon atom, silicon atom, nitrogen atom, oxygen atom, or sulfur atom on Y₍₁₆₎ₙ in the formula II.

2. The electrochemical apparatus according to claim 1, wherein the substance A comprises at least one of the following compounds:

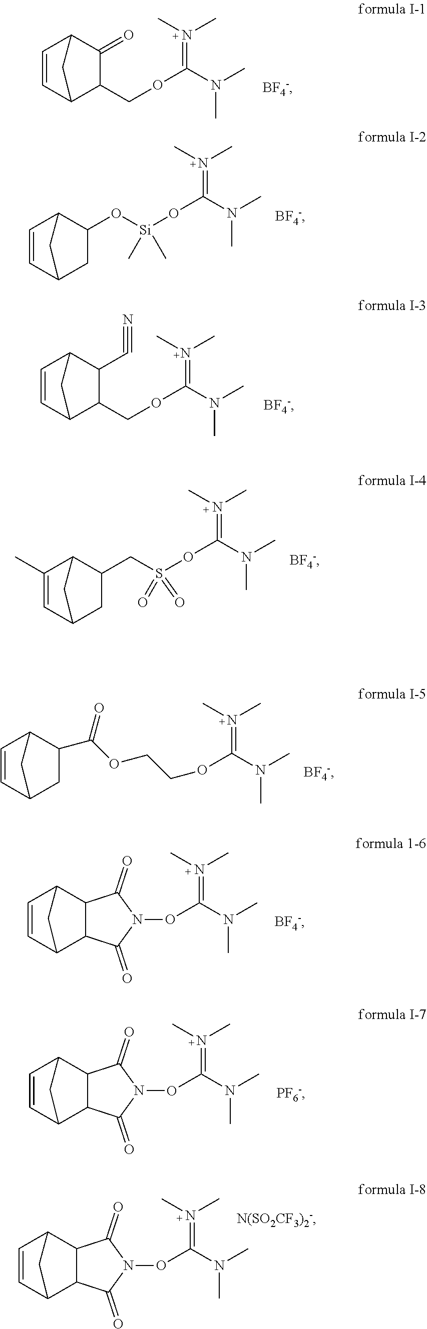

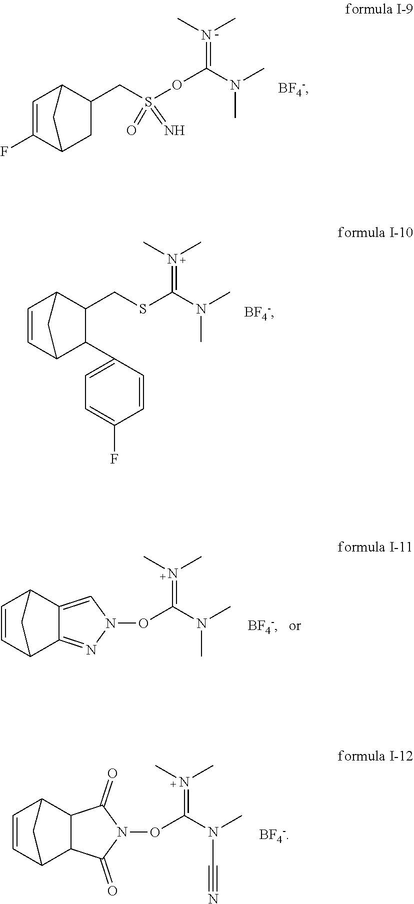

3. The electrochemical apparatus according to claim 1, wherein the electrochemical apparatus satisfies at least one of the following conditions:
$$0 \% \leq {X}_{1} \leq 70 \% , and 20 \% \leq {X}_{2} \leq 90 \% ; \qquad ( 1 )$$
(2) based on a mass of the electrolyte, a mass percentage of the substance A is a%, and 0.01≤a≤5.

4. The electrochemical apparatus according to claim 3, wherein the electrochemical apparatus satisfies at least one of the following conditions:
$$0 \% \leq {X}_{1} \leq 25 \% , 20 \% \leq {X}_{2} \leq 40 \% ; or \qquad ( 1 )$$
$$0.1 \leq a \leq 5. \qquad ( 2 )$$

5. The electrochemical apparatus according to claim 3, wherein 0.011≤a/X₂≤15.

6. The electrochemical apparatus according to claim 5, wherein 1.5≤a/X₂≤13.5.

7. The electrochemical apparatus according to claim 3, wherein the electrolyte further comprises fluoroethylene carbonate and carboxylic ester compounds; wherein based on the mass of the electrolyte, a mass percentage of fluoroethylene carbonate is b%, and a mass percentage of carboxylic ester compounds is c%, satisfying at least one of the following conditions:
$$0.05 \leq a / b \leq 1 ; \qquad ( 1 )$$
$$0.1 \leq ( b / c ) / {X}_{2} \leq 2.7 ; or \qquad ( 2 )$$
$$1 \leq b \leq 20. \qquad ( 3 )$$

8. The electrochemical apparatus according to claim 1, wherein the electrolyte further comprises a substance B; wherein
the substance B comprises at least one of vinylene carbonate, vinylethylene carbonate, 1,3-propene sultone, 1,3-propane sultone, 3-hexenedinitrile, maleic anhydride, or triallyl methoxysilane; and
based on a mass of the electrolyte, a mass percentage of the substance B is 0.1% to 4%.

9. The electrochemical apparatus according to claim 1, wherein the negative electrode film layer further comprises a carbon material; wherein
the carbon material is at least one selected from artificial graphite, natural graphite, soft carbon, or hard carbon;
the silicon material comprises a silicon composite material and/or elemental silicon, and the silicon composite material comprises a silicon carbon material and/or a silicon oxide material SiOₓ, wherein 0.5≤x≤1.5; and
the silicon carbon material contains silicon element, carbon element, and oxygen element, wherein a mass ratio of silicon element, carbon element, and oxygen element is from 1:1:1 to 6:3:0.

10. The electrochemical apparatus according to claim 1, wherein the electrochemical apparatus has a discharge voltage of less than 3.0 V during cycling.

11. An electronic apparatus, comprising an electrochemical apparatus, wherein the electrochemical apparatus comprises a negative electrode plate and an electrolyte;
wherein
the negative electrode plate comprises a negative electrode current collector and a negative electrode film layer disposed on at least one surface of the negative electrode current collector, and the negative electrode film layer contains a silicon material;
in a direction facing away from the negative electrode current collector, the negative electrode film layer sequentially comprises a first active substance layer and a second active substance layer, wherein X₁ is a mass percentage of the silicon material in the first active substance layer, X₂ is a mass percentage of the silicon material in the second active substance layer, X₁<X₂; and
the electrolyte comprises a substance A with a structure shown in formula I; 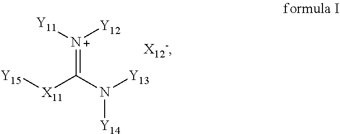
wherein
in the formula I, X₁₁ is at least one selected from oxygen, sulfur, oxygen-containing alkylene group of C₁ to C₅, or sulfur-containing alkylene group of C₁ to C₅; X₁₂⁻ is a fluorine-containing anion, and X₁₂⁻ is at least one selected from BF₄⁻, PF₆⁻, SO₃CF₃⁻, N(SO₂CF₃)₂⁻, CO₂CF₃⁻, N(SO₂C₂F₅)₂⁻, N(SO₂C₄F₉)₂⁻, C₃N₂(CN)₂(CF₃)⁻, or C₃N₂(CN)₂(C₂F₅)⁻;
Y₁₁ to Y₁₄ are each independently selected from acyloxy group, cyano group, isocyano group, substituted or unsubstituted alkyl group of C₁ to C₅, substituted or unsubstituted alkenyl group of C₂ to C₅, substituted or unsubstituted aryl group, or substituted or unsubstituted alkoxy group of C₁ to C₅; and in a case of substitution, the substituent group is each independently selected from fluorine, or alkyl group of C₁ to C₄;
Y₁₅ is selected from the group shown in formula II; 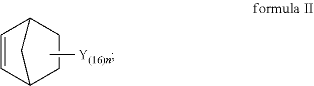
wherein
in the formula II, Y₍₁₆₎ₙ is selected from keto group, aldehyde group, substituted or unsubstituted alkyl group of C₁ to C₅, substituted or unsubstituted alkenyl group of C₂ to C₅, substituted or unsubstituted aryl group, amino group, nitro group, acyloxy group, substituted or unsubstituted alkoxy group of C₁ to C₅, siloxane group, carboxyester group, carbonate group, sulfonate group, sulfinate group, phosphate group, phosphinate group, cyano group, isocyano group, succinimide group, maleimide group, sulfonimide group, or heterocyclic group; and in a case of substitution, the substituent group is each independently selected from fluorine, or alkyl group of C₁ to C₄;
X₁₁ and Y₁₅ are connected through a carbon atom in the formula II; or,
X₁₁ and Y₁₅ are connected through a carbon atom, silicon atom, nitrogen atom, oxygen atom, or sulfur atom on Y₍₁₆₎ₙ in the formula II.

12. The electronic apparatus according to claim 11, wherein the substance A comprises at least one of the following compounds:

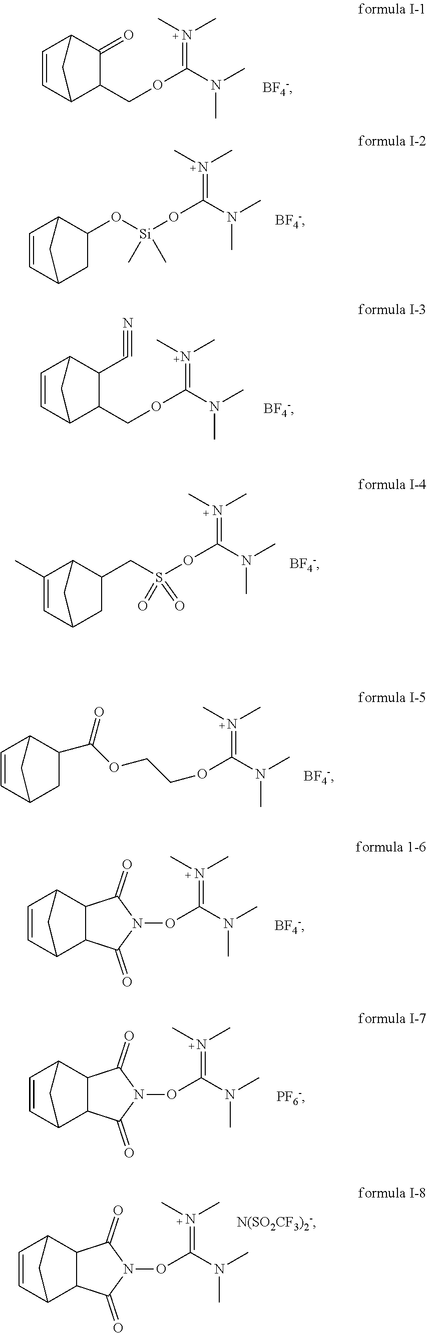

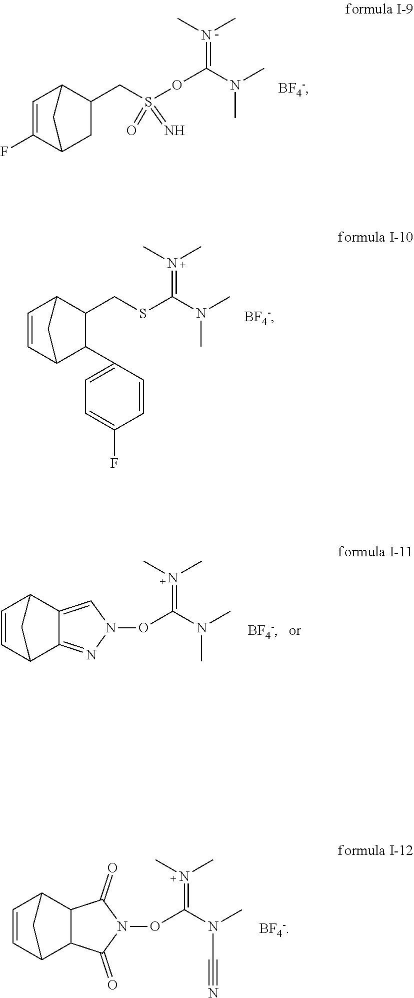

13. The electronic apparatus according to claim 11, wherein the electrochemical apparatus satisfies at least one of the following conditions:
(1) 0%≤X₁≤70%, and 20%≤X₂≤90%; or
(2) based on a mass of the electrolyte, a mass percentage of the substance A is a%, and 0.01≤a≤5.

14. The electronic apparatus according to claim 13, wherein the electrochemical apparatus satisfies at least one of the following conditions:
(1) 0%≤X₁≤25%, 20%≤X₂≤40%; or
(2) 0.1≤a≤5.

15. The electronic apparatus according to claim 13, wherein 0.011≤a/X₂≤15.

16. The electronic apparatus according to claim 15, wherein 1.5≤a/X₂≤13.5.

17. The electronic apparatus according to claim 13, wherein the electrolyte further comprises fluoroethylene carbonate and carboxylic ester compounds, wherein based on the mass of the electrolyte, a mass percentage of fluoroethylene carbonate is b%, and a mass percentage of carboxylic ester compounds is c%, satisfying at least one of the following conditions:
$$0.05 \leq a / b \leq 1 ; \qquad ( 1 )$$
$$0.1 \leq ( b / c ) / {X}_{2} \leq 2.7 ; or \qquad ( 2 )$$
$$1 \leq b \leq 20. \qquad ( 3 )$$

18. The electronic apparatus according to claim 11, wherein the electrolyte further comprises a substance B; wherein
the substance B comprises at least one of vinylene carbonate, vinylethylene carbonate, 1,3-propene sultone, 1,3-propane sultone, 3-hexenedinitrile, maleic anhydride, or triallyl methoxysilane; and
based on a mass of the electrolyte, a mass percentage of the substance B is 0.1% to 4%.

19. The electronic apparatus according to claim 11, wherein the negative electrode film layer further comprises a carbon material; wherein
the carbon material is at least one selected from artificial graphite, natural graphite, soft carbon, or hard carbon;
the silicon material comprises a silicon composite material and/or elemental silicon, and the silicon composite material comprises a silicon carbon material and/or a silicon oxide material SiOₓ, wherein 0.5≤x≤1.5; and
the silicon carbon material contains silicon element, carbon element, and oxygen element, wherein a mass ratio of silicon element, carbon element, and oxygen element is from 1:1:1 to 6:3:0.

20. The electronic apparatus according to claim 11, wherein the electrochemical apparatus has a discharge voltage of less than 3.0 V during cycling.
